(19) United States
(12) Patent Application Publication
(10) Pub. No.: US 2012/0181307 A1
(43) Pub. Date: Jul. 19, 2012

(54) POUR SPOUT

(76) Inventor: Jamey Grosser, Nashville, TN (US)

(21) Appl. No.: 13/351,692

(22) Filed: Jan. 17, 2012

Related U.S. Application Data
(60) Provisional application No. 61/433,386, filed on Jan. 17, 2011.

(51) Int. Cl. B67D 3/00; B65D 25/48

(52) U.S. Cl. 222/478; 222/568

(57) ABSTRACT

A pour spout includes a lid of a wide-mouthed container adapted to provide a channel through the lid to pour a liquid from the inside of the container to the outside. A pour spout made from a lid of a wide-mouthed container affixed to a spout from a narrow-necked bottle.

### CLAIM OF PRIORITY

This application claims the benefit of priority under 35 U.S.C. §119(e) to U.S. provisional application Ser. No. 61/433,386, filed Jan. 17, 2011, which is incorporated herein by reference in its entirety.

### TECHNICAL FIELD

The technology described herein generally relates to pour spouts, and more particularly relates to a cap for a wide-mouthed container, which has been adapted for pouring the contents of the container with the cap in place.

### BACKGROUND

Liquids and other dispensable materials, such as powders, gels, and granules, have been stored in a variety of containers having lids, caps, or stoppers adapted to permit pouring or decanting of the materials.

A number of different pour spouts have been developed to both address the types of liquid or powders, etc., that might need to be poured from a container, as well as fit the range of containers that have been used to store the liquids.

However, the huge range of different types of spouts as well as the enormous range of types of containers means that many spouts have never been considered practical or suitable in combination with particular containers. Practical considerations as well as tradition have played a role in determining the combinations of pour spouts and container types currently available.

Alcoholic beverages such as whiskey have normally been stored and shipped in, and served from, bottles with narrow necks. To convert such bottles from a shipping and storing role to a serving role, they have typically been fitted with specially adapted pour spouts that seal the top of the bottle and provide a metered flow of liquor when dispensing a shot. A bottle fitted with such a pour spout can conveniently be kept behind a bar, such as in an inn or restaurant, and used to dispense a drink to a customer on demand.

Other types of container, however, would not be suitable for this purpose. For example, a wide-mouthed jar may conveniently store liquor but would be a difficult receptacle from which to pour or dispense liquor. Recently, however, it has become popular to deliver traditional forms of liquor to bars and restaurants in wide-mouthed jars, such as Mason jars, and thereby emphasize aspects of the liquor's heritage. Accordingly, there is a need for a device and method of adapting such a wide-mouthed jar to effectively dispense the liquor.

The discussion of the background herein is included to explain the context of the technology. This is not to be taken as an admission that any of the material referred to was published, known, or part of the common general knowledge as at the priority date of any of the claims found appended hereto.

Throughout the description and claims of the specification the word “comprise” and variations thereof, such as “comprising” and “comprises”, is not intended to exclude other additives, components, integers or steps.

### SUMMARY

The instant disclosure includes a pour spout, comprising: a lid of a wide-mouthed container adapted to provide a channel through the lid to pour a liquid from the inside of the container to the outside.

The disclosure further includes a pour spout, comprising: a lid of a wide-mouthed container affixed to a spout from a narrow-necked bottle.

The present disclosure includes particular embodiments of pour spout, such as wherein the wide-mouthed container is a Mason jar.

The present disclosure further includes a kit that contains a number of wide-mouthed containers, such as Mason jars, alongside one or more pour spouts as described herein.

The pour spouts described herein are particularly suitable for dispensing an alcoholic beverage such as whiskey from a wide-mouthed container such as a Mason jar.

The present disclosure still further includes one or more processes for making, such as assembling, the pour spouts described herein.

### BRIEF DESCRIPTION OF THE DRAWINGS

FIG. 1 shows a side perspective view of an exemplary pour spout as described herein;

FIG. 2 shows a view of an underside of an exemplary pour spout as described herein; and

FIG. 3 shows an elevated perspective view of an exemplary pour spout as described herein.

FIGS. 4A-4F show various stages in an assembly of an exemplary pour spout as described herein.

Like reference symbols in the various drawings indicate like elements. The drawings are presented in black and white herein.

### DETAILED DESCRIPTION

The instant technology is directed to a pour spout for use with a wide-mouthed jar, such as a Mason jar, and particularly provides a person with the ability to successfully and conveniently dispense a liquid such as an alcoholic beverage from the jar into, for example, a customer's glass. A successful and convenient manner of dispensing the liquid includes the possibility of dispensing the liquid with no, or an insignificant amount of, wastage through slop or spill. The successful and convenient manner of dispensing may additionally include the ability to dispense a controlled amount of the liquid repeatedly, reliably, and without difficulty or further adaptation.

A particular application of the technology herein is to address the practical need of dispensing a non-viscous liquid such as liquor from a wide-mouthed jar such as a Mason jar. Legal and licensing requirements impose a need to have a pour counter on a bottle containing liquor, but the mouth size of a Mason jar both impedes effective pouring and does not permit use of a standard pour spout that is normally attached to a wine, spirit, or liquor bottle. A Mason jar has been found to be an elegant receptacle for shipping, storing, and displaying a distilled liquor or spirit, and one that catches a customer's eye, creates a point of discussion, and entices a customer to purchase a quantity of the beverage stored in the jar. A specially adapted pour spout permits a waiter or bar-tender to serve the drink directly from the jar.

### DEFINITIONS

A pour spout, as used herein, refers to a device that channels fluid, or other pourable material such as a powder, from inside a vessel or container to the outside of the vessel or container in a controlled manner. Particularly preferred pour spouts are those adapted to dispense liquid such as liquor in controlled amounts.

The term wide-mouthed container, or wide-mouthed jar, is used herein consistent with its understanding in the art. Typically, wide-mouthed containers have circular openings of standard diameter 3⅛″, although the jars may have a variety of sizes (as measured by, e.g., diameter or volume). The term can refer to a container or vessel having an opening that is only slightly narrower than the main body of the container. The term includes, however, containers whose opening is one of the standard diameters, e.g., 3⅛″, even though that diameter is substantially narrower than the main body of the container. Exemplary wide-mouthed jars compatible with the pour spout herein include jars commonly known as Mason jars, canning jars, and “Ball” jars. Such jars come in standard sizes such as ½ pint, 1 pint, 1 quart, and ½ gallon. They typically do not have a handle or handles, but variants styled as Mason jar mugs are available. Other sizes or shapes of wide-mouthed jars are available for storing other foodstuffs such as preserves, honey, relishes, herbs, and spices. One particularly preferred variety of wide-mouthed jar is a Mason jar used for storing distilled liquor such as whiskey. It is to be understood that the pour spout herein is not limited in its use and adaptation to a particular diameter of opening, or size or shape of jar. For example, metric equivalents may be in use. The sizes referenced herein may be widely used in food storage, and catering, but are not the only sizes that may be encountered, and to which the pour spout and methods of making it are applicable or adaptable.

Wide-mouthed containers are typically made of glass, but may occasionally be made of plastic such as heavy-duty plastic that can be reused. The pour spout herein may be used with wide-mouthed containers made of glass or plastic, or even other materials such as metals, or ceramics.

Wide-mouthed jars typically have a threaded top that accepts a complementarily threaded cap. Such caps are typically made of metal or plastic (or some combination of the two materials), and may be moulded as a single piece, or may be offered as a 2-piece item comprising a threaded rim, and a circular cap that is held between a flange on the rim and the mouth of the jar, thereby creating a seal.

Other caps for wide-mouthed jars include a “lug cap”, wire bale cap (such as creates an air seal), and plastic screw caps. The technology herein may be applied to such caps.

### Exemplary Embodiment

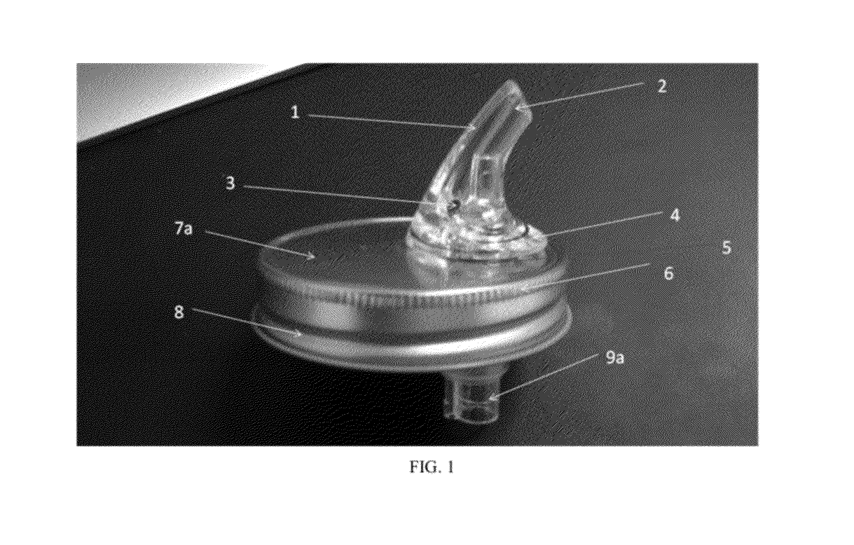

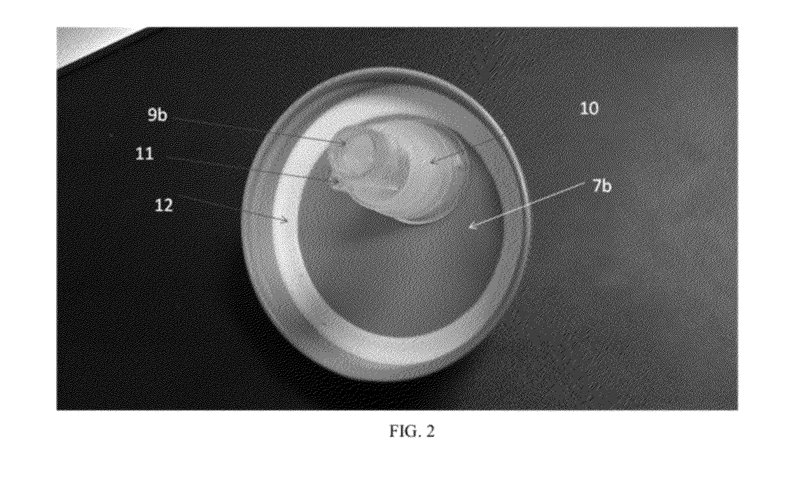

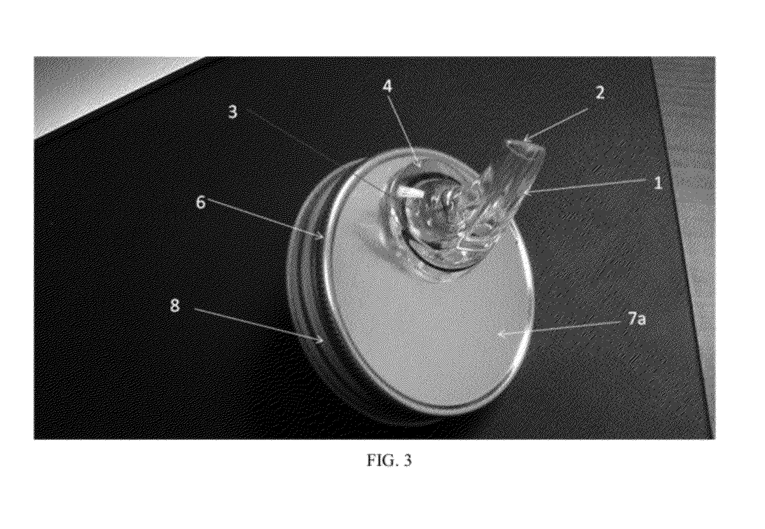

An exemplary embodiment of a pour spout for use with a wide-mouthed jar is shown in FIGS. 1-3, and is described as follows.

The pour spout comprises a spout 1, also referred to herein as a liquor pourer, affixed to a lid shown with upper surface 7a, and inside (obverse) surface 7b. The lid is also referred to herein as lid 7, and is a lid that may suitably seal a wide-mouthed jar such as a Mason jar. A particularly preferred lid is that shown, and is a single piece, made of a lightweight metal such as Aluminum, Tin, or an alloy thereof, and attaches to a wide-mouthed jar such as a Mason jar via a screw-thread 8. It may optionally have a beveled rim 6 to facilitate grip, or for ornamental purposes. Underside 7b of lid 7 may optionally have a ring of soft material 12 such as a foam or deformable plastic to make an improved seal on the neck of the wide-mouthed jar.

Spout 1 is mounted to lid 7 to provide a channel for decanting liquid from the interior of the wide-mouthed jar to the outside of the jar when the pour spout is attached to the jar. Liquid such as a liquor exits the spout 1 at nozzle 2. It is to be understood that a number of spouts 1 are consistent with the overall operation of the pour spout. In the exemplary embodiment of FIGS. 1-3, the spout 1 is commercially available as Liquor Saver 2000, (in a number of colors) from Magnuson Industries, Inc., Rockford, Ill., and is designed for use with a narrow-neck bottle such as a liquor or wine bottle that is normally sealed with a cork or may have a screw-cap, and replaces that cork or screw-cap when in use. Other similar spouts having different shapes and appearances, but which also work on liquor or wine bottles, could be used in place of spout 1 in FIGS. 1-3. For example, it is not required that the spout 1 be made of a transparent plastic, but instead it could be made from an opaque or translucent plastic. Spout 1 can also be made of metal. Spouts 1 are typically configured to deliver a metered volume of liquid in a single ‘shot’, to a high degree of reliability.

Exemplary spouts, or ‘liquor pourers’ for use in the pour spout described herein, include, but are not limited to, those available from www.foodservicewarehouse.com/bar/liquor-pourers, such as: Magnuson Industries Plastic Free Pourers #410-417; Winco flexible plastic pourer PPR-1; Update International 3″ Free-Flow Speed Pourers (POR-RD); American Metalcraft 1 oz, 1.25 oz, and 1.5 oz plastic pourers, ## MPC100, MPC125, MPC150, MPC100C, MPC125C, and MPC150C; Spill-stop Plastic Whiskeygate (320-00); Magnuson Industries Plastic Whiskey Gate Free Pourers, ##210A, 210B, 210C, 210D, 210E, 210F, 211A, 211B, and 211C; Espresso Supply 1 oz Plastic Precision Pour Spout (03791); Magnuson Industries Plastic Free Pourers—“Posi-Pour II”, and “Posi-Pour 2000” series, both in varying dispense sizes; Update International (POR-MT)-4½″ Stainless Steel Free-Flow Speed Pourer; Magnuson Industries—Plastic Screened Free Pourers, ##313-A, 313-B, 313-C, 313-G, and 313-R; Magnuson Industries Plastic Juice Jet Free Pourers; Magnuson Industries (285)—Chrome Metal Free Pourers; Spill-Stop Flashing Bottle Pourer (300-series); Espresso Supply Chrome Pour Spout; Spill-Stop—Plastic Pourer (350-series); Magnuson Industries Plastic Measured Pourers—“Posi-Pour I” Series, in—⅝ oz, ¾ oz, ⅞ oz, 1 oz, 1⅛ oz, and 1½ oz; Spill-Stop—Plastic Speed Pourer (355-series). This list is not intended to be exhaustive, but is illustrative of the wide variety of styles of spouts that can be adapted for use herein.

The exemplary pour spouts in the aforementioned list include the ‘collared’ and non-collared variety, either of which can be used with the technology herein.

The exemplary pour spouts are also available in a number of cork sizes (as applicable to narrow-neck liquor or wine bottles), and, correspondingly, any of which can be used with the technology herein.

Typical dispense volumes of pour spouts suitable for use with a wide-mouthed container include, but are not limited to: 0.5 oz; 0.625 oz; 0.75 oz; 0.875 oz; 1 oz; 1.125 oz; 1.25 oz; 1.5 oz; 1.75 oz, and 2.0 oz. It is understood that the dispense volumes as quoted may be approximate and may deviate by as much as +/−10% from the quoted volume. Volumes may be quoted in fluid ounces, as applicable. Metric equivalent volumes may be used interchangeably with the technology herein.

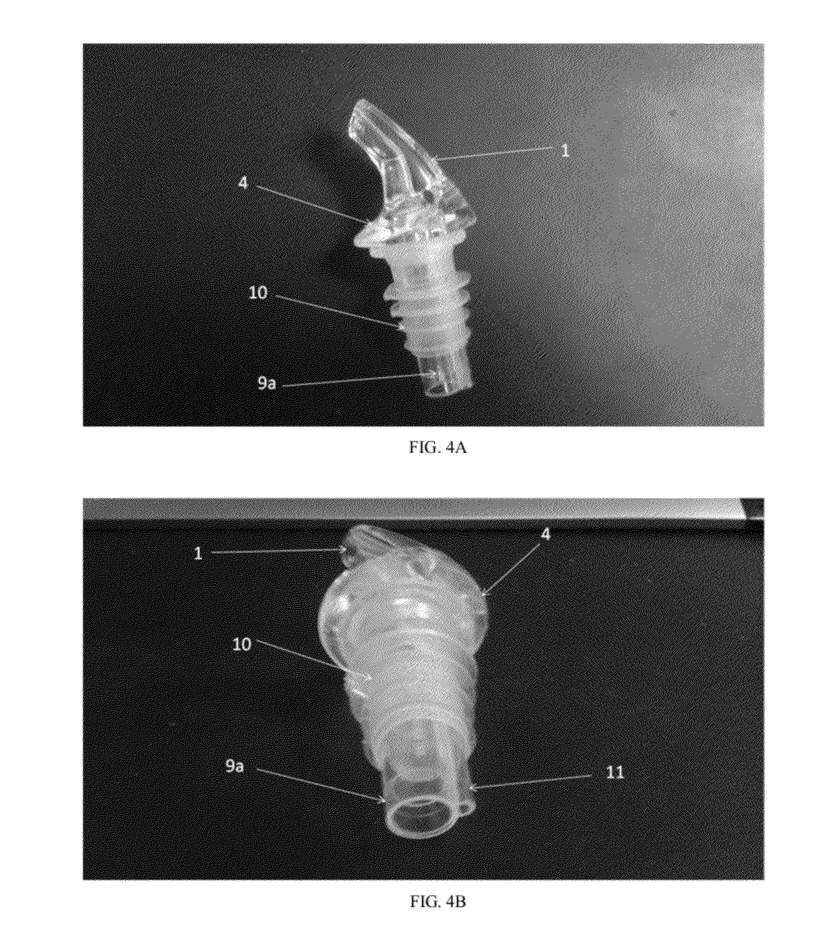

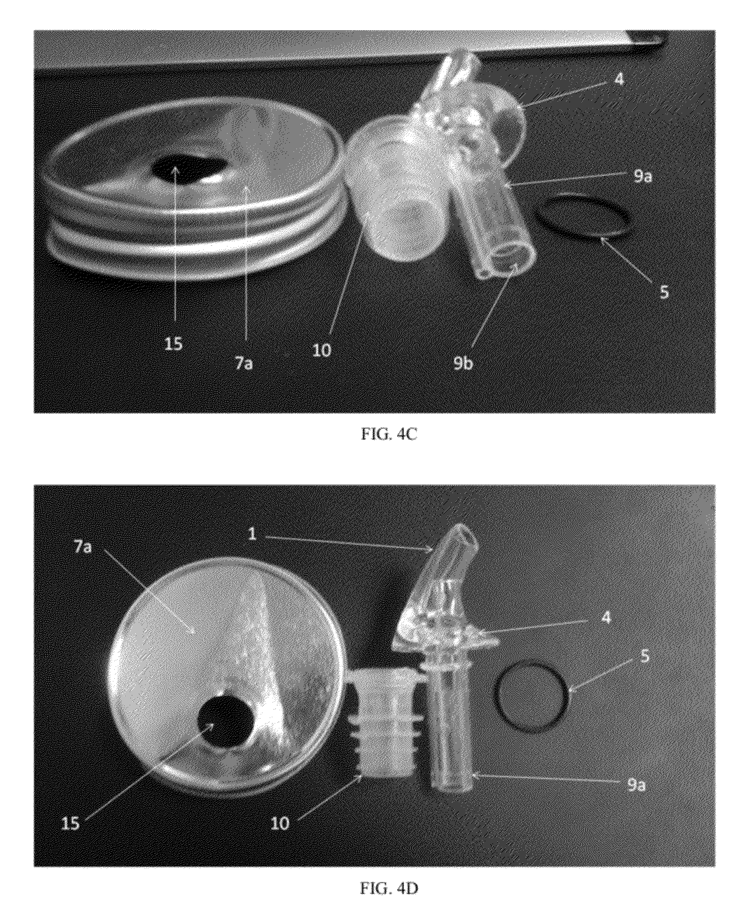

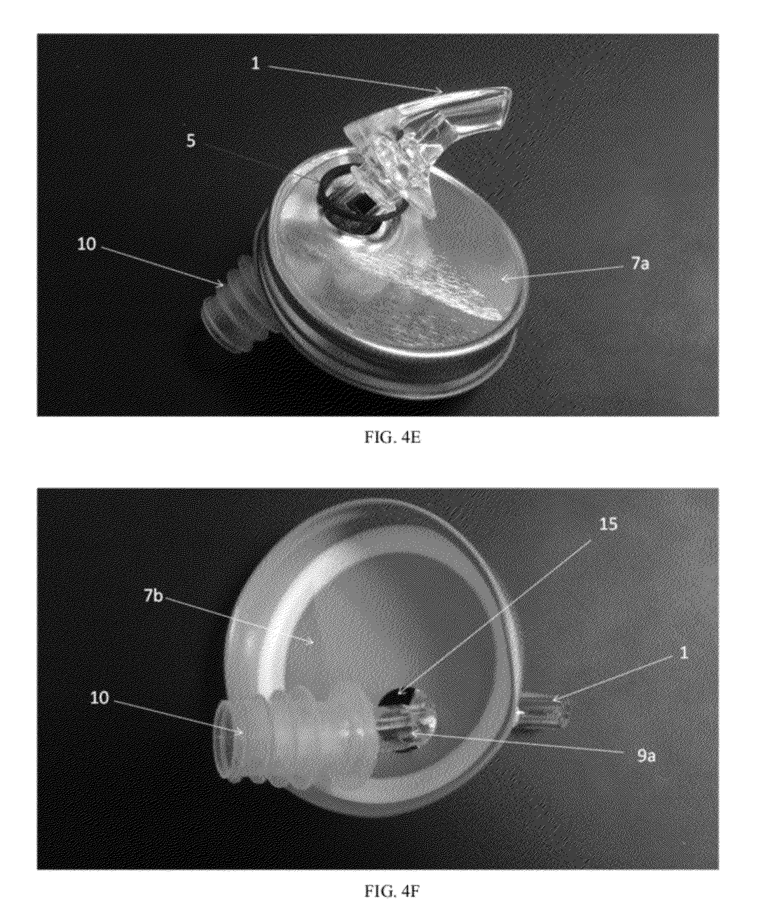

General features of spout 1, that admit of variations of shape, size, color, and style, include the nozzle 2, a neck having outer surface 9a, and inner surface 9b (together referred to herein as neck 9) protruding from the inside of lid 7, and an air channel having inlet 11 on the inside of the lid 7 and an outlet 3 on the outside of lid 7. The air channel provides pressure for pouring and is separated from the channel through which liquid flows. Specifically, as shown in FIGS. 1-3, inlet 11 runs approximately vertically alongside the channel through which liquid flows, and is in fluid connectivity with a horizontal channel that runs through the spout 1 from one side to an opposite side, creating outlet 3. The horizontal and vertical channels therefore meet at a “T” in the embodiment shown. Outlet 3 is also clearly visible in FIG. 4A, described hereinbelow. The air channel configuration in FIGS. 1-3 is exemplary, and not limiting of the design or function of the pour spout herein; other configurations of air channel, offering equivalent functionality, are consistent with the technology herein.

Spout 1 may be attached to lid 7 by any of a variety of ways. A hole (not apparent in FIGS. 1-3) is required to be made, for example by punching or drilling, in lid 7. A spout 1 can then be inserted through the hole, and attached to the lid by a glue or mechanical force. Other methods of assembling the pour spout are further described herein. The hole is preferably positioned at a location in lid 7 offset from its geometric center, as shown in FIGS. 1-3. Such a position is preferable for pouring, e.g., liquor. Other locations, such as nearer to the center, and at the center itself may be practical for other applications. It would be understood that different designs of spout may require variations in attachment methods to the lid 7. An exemplary assembly method is shown and described elsewhere herein.

In the embodiment of FIGS. 1-3, the spout 1 has a flange 4 that facilitates mounting on the outer surface 7a of the lid. Since it is important that liquid does not escape from the mounting area during pouring, a seal 5 is typically positioned between the base of the spout and outer surface 7a.

The portion of spout 1 that is visible on the underside of lid 7 is consistent with a spout that is used in a narrow-neck bottle and therefore shows features that may not be necessary to the functioning of the pour spout when mounted on a wide-mouthed jar such as a Mason jar. In particular thread 10 (also referred to herein as a sheath) is part of a pour spout assembly that creates a seal in a narrow-bottle neck and is not required for use with a wide-mouthed container. It may be left in place if consistent with ease of manufacture of the pour spout herein, but may also be removed. Nozzle 9, having outer surface 9a and inner surface 9b, need not protrude as deeply into the interior of the wide-mouthed container as is shown in FIGS. 1-3. In other embodiments the assembly containing the air channel and the channel through which liquid flows are shorter.

### Exemplary Method of Assembly

FIGS. 4A-4F, show various stages in the assembly of an exemplary pour spout as shown in FIGS. 1-3, and as described elsewhere herein. In all of the images in FIGS. 4A-4F, the lid 7 is slightly deformed, a damage resulting from its disassembly in preparation of the images. The deformations are inconsequential and are not to be taken to detract from the efficacy of the methods described herein, or to be limiting of the design or appearance.

It would be understood that the method of assembly described herein could readily be performed with many other commercially available liquor pourers (such as those listed elsewhere herein) and wide-mouthed jar caps, and is not limited to the specific embodiment in the drawings. It would also be understood that an actual method of assembly as performed would not necessarily follow the steps in the order as described herein, and presented in the figures in sequence. Specifically, the various steps of assembly could in many instances be performed in orders other than those described herein, and in some instances, where different pieces are concerned, in parallel (i.e., in part simultaneously with one another).

FIGS. 4A and 4B show, respectively, a plan view and a perspective view from beneath, of a commercially available liquor pourer in its form as purchased (i.e., assembled) and prior to its adaptation for the pour spout described herein. The spout 1 is made up of the single piece of hard plastic, a “disc base” 4 (which ultimately sits atop the wide-mouthed jar lid) and a “neck” having outer surface 9a (which protrudes into the bottle when the spout is affixed to the wide-mouthed jar lid). Surrounding the outer surface of neck 9a is a softer plastic or rubber threaded sheath 10 which is held in place by mechanical force. Tube 11 is an air passage that provides pressure for pouring.

For assembly of a pour spout as described herein, the sheath 10 is removed from the neck 9a.

FIGS. 4C and 4D show, respectively, perspective and plan views of the various pieces of the exemplary pour spout as described herein, in disassembled form, and prior to assembly according to a method described herein. Specifically, FIGS. 4C and 4D show the lid 7, the sheath 10, and spout 1 portions of the liquor pourer (disassembled) and the gasket 5.

A hole 15 is created in the wide-mouthed jar lid 7. It can be created by drilling, puncturing, punching, cutting, or boring. It is preferably circular and is of a diameter that accommodates the outer surface of neck 9a snugly so that the liquor pourer does not easily or appreciably move from side to side when inserted through the hole 15.

FIGS. 4E and 4F show the 4 pieces (lid 7, liquor pourer 1, sheath 10, and gasket 5) in the process of assembly, and prior to the sheath 10 being fully pressed into place around the neck and snug against the lower surface of lid 7b.

A circular rubber gasket or “O-ring” 5 is placed so that it lies around the perimeter of the hole 15 on the top surface 7a of the wide-mouthed jar lid. In other methods of assembly and with differently configured liquor pourers, gasket 5 may be placed on the under surface 7b of the lid. In some instances, simple placement of gasket 5 on one or other surface of the lid is not sufficient to create a seal, and the gasket is affixed by a suitable adhesive to the surface of the lid.

The neck piece 9 of the liquor pourer is inserted through the hole from the same side on which the gasket is situated, so that the neck protrudes through the obverse side of the lid, and so that the disc base of the liquor pourer sandwiches the rubber gasket between the disc base and the lid. The result of this is that the spout of the liquor pourer sits on the upper side 7a of the lid. It can be secured to the lid from the other side, for example, by methods described further herein.

The sheath 10 is then placed back around the outer surface of neck 9a. In some embodiments it is secured in place by friction by virtue of the fact that it forms a tight seal around the outer surface of neck 9a. It may, in other embodiments, be secured in place again by a mechanical fixture. This may be a member that is complementary to and engages with a member on the neck 9a. For example, a lip or a ridge on the neck may join to a groove on the inside surface of the sheath. Specifically, a lip that runs circumferentially around the outer surface of the neck, and made of a hard plastic, may engage with a groove or complementary lip on the inner surface of the sheath, which is made of a softer, more easily deformable plastic. The connection between the two holds the sheath and neck together securely, and also keeps them securely fastened to the lid, preventing the liquor pourer from moving vertically through the hole in the lid. If the length of the neck protruding beneath the lower surface 7b of the lid is too long for convenient use, it can be trimmed down after assembly with minimal impact on function.

In the exemplary embodiment of FIGS. 4A-4F, the sheath 10 is one that was originally affixed to the liquor pourer obtained from narrow-neck bottle usage. This is convenient because it permits all components of the liquor pourer to be used without requiring further components to be manufactured or purchased. It is to be understood, however, that other forms of sheath 10 could be deployed if it is preferred to use a design that does not, for example, have an external thread, or made from a different material, or of a shorter length.

It is to be understood that other methods of assembly of a pour spout as described herein can be envisaged, and may be implemented as particular variants of liquor pourer are adapted. For example, some liquor pourers may lend themselves to being cut in half, thereby separating a spout portion to be positioned on the upper surface of the lid, from a neck portion to protrude below the lower surface of the lid. The two separate pieces can be attached to either respective side of a lid, concentric with a previously-made hole in the lid, by, for example, an adhesive, such as glue.

In still other embodiments of making the pour spout as described herein, it may be sufficient to create a seal by forcing a neck of a liquor pourer through a pre-made hole in a lid of a wide-mouthed container. Such an approach could be deployed with or without a gasket. The snugness of fit between the outer surface of the neck of the liquor pourer and the inner rim of the hole in the lid is mostly responsible for the seal.

The pour spout described herein may be sold as a separate unit, for use with any suitable wide-mouthed jar, or may be shipped and sold with a wide-mouth jar, or case of wide-mouthed jars such as Mason jars. For example, when shipping liquor to a bar or restaurant, a case of 4, 6, 8, 10, 12, or 20 Mason jars of liquor, each individually capped with standard lids, can be accompanied by 1, 2, or 3 pour spouts as described herein, each of which can be applied to the mason jars as each is used, and the spouts can then be reused.

The foregoing description is intended to illustrate various aspects of the instant technology. It is not intended that the examples presented herein limit the scope of the appended claims. The technology now being fully described, it will be apparent to one of ordinary skill in the art that many changes and modifications can be made thereto without departing from the spirit or scope of the appended claims.

What is claimed:

1. A pour spout, comprising:
a lid of a wide-mouthed container adapted to provide a channel through the lid to pour a liquid from the inside of the container to the outside.

2. The pour spout of claim 1, wherein the wide-mouthed container is a Mason jar.

3. The pour spout of claim 1, wherein the lid is threaded and is configured to screw onto the wide-mouthed container.

4. A kit containing a plurality of Mason jars and one or more pour spouts according to claim 1.

5. The kit of claim 4, wherein the Mason jars contain liquor.

6. A pour spout, comprising:
a lid of a wide-mouthed container affixed to a spout from a narrow-necked bottle.

7. The pour spout of claim 6, wherein the wide-mouthed container is a Mason jar.

8. The pour spout of claim 6, wherein the lid is threaded and is configured to screw onto the wide-mouthed container.

9. The pour spout of claim 6, wherein the spout from the narrow-necked bottle comprises an air channel and a channel through which liquid passes.

10. The pour spout of claim 6 wherein the spout and the lid are affixed to one another with a seal to prevent liquid leaking from within the wide-mouthed container when in use.

11. A kit containing a plurality of Mason jars and one or more pour spouts according to claim 6.

12. The kit of claim 11, wherein the Mason jars contain liquor.
